(19) United States
(12) Patent Application Publication
(10) Pub. No.: US 2009/0044411 A1
(43) Pub. Date: Feb. 19, 2009

(54) Shears with Detachable Comb and Attachment Mechanism

(76) Inventor: Nancy Cotant, Springville, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 12/175,216

(22) Filed: Jul. 17, 2008

Related U.S. Application Data
(60) Provisional application No. 60/950,228, filed on Jul. 17, 2007.

(51) Int. Cl. B26B 13/24; A45D 24/36

(52) U.S. Cl. 30/233.5; 132/213.1

(57) ABSTRACT

A tonsorial device includes a pair of shears, each shear having a handle and a cutting blade, a pivot assembly pivotally attaching the shears at a preselected location between the handles and the cutting blades, and
a comb detachably connected to the pair of shears. The comb may be attached through any number of means including magnets, channels, bolts, voids, and clips. One purpose of the system and method is to provide a shears and comb combination wherein the comb is easily attached and detached as desired.

### RELATED APPLICATIONS

This application claims the benefit under 35 U.S.C. §119(e) of U.S. Provisional Patent Application No. 60/950,228 filed Jul. 17, 2007 titled “Hair Cutting Scissors with Integrated Comb”. The above-mentioned application is incorporated herein by reference in its entirety.

### TECHNICAL FIELD

The present specification relates generally to tonsorial devices. More particularly, the present specification relates to shears having a detachable comb and the attachment mechanism thereof.

### BACKGROUND

Hairstylists and barbers currently use a method for cutting hair in which a pair of shears is held in one hand, while a comb is passed back and forth between hands. The comb is held in the dominant hand to comb the hair and then transferred to the other hand before a cut is made. The transfer of the comb between hands may be repeated many times within a single haircut. Obviously the time spent transferring the comb and shears from one hand to another increases the time to complete the task and causes excess stress on the stylist's upper limbs and neck. The repetition of this transfer during the course of a stylist's career results in a decrease in efficiency and an increase in the likelihood of injury arising from repetitive stress.

Tonsorial tools comprising a pair of shears in combination with a comb are known in the art. Current devices generally include a pair of shears with a comb integrally formed therewith. In such devices, comb teeth extend from the spine of one or both blades of a pair of shears. However, these devices carry inherent disadvantages that outweigh those of the current method of cutting hair. One of the most significant disadvantages is that, since the comb portion is integrally formed with the shears portion of these devices, to sanitize either the comb or the shears, the whole device must be sanitized, rather than only the portion needing sanitization. Another disadvantage lies in the limited versatility of the one set of comb teeth present on a single device. In order to use a different type of comb with a given pair of shears, multiple complete tools must be purchased having different comb portions, thereby increasing the expense of using such devices.

Other devices are known in the art that theoretically overcome these disadvantages, but fail to do so in a manner efficient enough for them to actually be used frequently. For example, U.S. Pat. No. 1,806,486 to Mirafuentes (Mirafuentes) discloses a pair of hair cutting shears having a removable comb attached thereto. This device may overcome the two disadvantages set forth above regarding integrally formed comb-and-shears devices, but the mechanism by which the comb is attached to the shears is too cumbersome to be useful to a hairstylist in practice. The mechanism disclosed for attaching the comb to the shears includes two threaded screws that attach the comb to one blade of the shears. As shown in the figures of Mirafuentes, the screws require manipulation by a tool, such as a screwdriver, thereby making the device an impractical means for overcoming the aforementioned disadvantages in an efficient manner. The difficulty of use outweighs the benefits of the design.

Yet still other devices are known in the art that theoretically overcome these disadvantages. U.S. Pat. No. 6,526,663 to Simmons et al. discloses a pair of hair gutting shears having a removable comb attached to the shears. Simmons discloses a comb that includes a notch located in the proximal end of the comb, which receives the collar of a nut to attach the shears. The comb also includes a channel disposed along the spine thereof, whereby one blade of a pair of shears is received. The comb may be attached to a pair of shears by sliding the non-cutting side of a blade of the shears into the channel and sliding the nut into the notch included therein. Although the shears disclosed by Simmons overcome many disadvantages of previous incarnations of shears, they have several shortcomings.

All of the comb-shears combinations in the prior art require that a new pair of shears must be obtained in order to benefit from the combination of the comb and shears. The combs in the prior art are made to fit only the specially designed shears or scissors. The shears that Simmons discloses have a special nut or bolt that protrudes from one of the blades, giving the comb a point of attachment. The scissors that Mirafuentes discloses require a special plate with holes in it to accept threaded screws.

Many hairstylists and barbers have a preference as to the style, shape, or brand of scissors they use. Indeed the comb-shears combinations are largely unused among professionals in the industry for this reason. The hairstylists and barbers prefer the way that a particular style or brand of scissors cut or fit their hands. Many other people who are not professional hairstylists or barbers also cut hair. Many of these people may not use their scissors enough to warrant buying an entire new pair of scissors simply to enjoy the added benefit of the attached comb.

It is therefore desirable to provide a tonsorial device including a comb-and-shears apparatus by providing a comb which may attach to any pair of scissors that are already in the possession of the user. It is also desirable that such a device allows for the quick and efficient removal of the comb portion from the shears portion, while allowing a variety of types of shears to be used with a variety of combs.

### SUMMARY

In one of the many possible embodiments, a comb is configured to be attached to a pair of shears by a magnet or a series of magnets. According to several embodiments, the comb is detachably secured to one blade of the shears. It is secured in such manner so as to make it convenient for the user to attach and detach the comb as is desired. According to an alternative embodiment, the comb may be fixedly attached to the pair of shears by an adhesive, glue, epoxy, Velcro™, or any other fixation means, such as welding or soldering.

According to an alternative embodiment, the shears and comb are configured with protrusions and corresponding orifices. The comb is attached to the shears by mating the protrusions with the orifices. According to one exemplary embodiment, and as is illustrated, the comb is configured with orifices or thru-bores on one blade of the shears configured to receive protruding members on the comb. According to a similar alternative embodiment, the shears are configured with thru-bores or orifices and the comb has corresponding protruding members configured to be mated with the shears.

According to an alternative embodiment, the comb is specifically configured with an attachment mechanism. The attachment mechanism allows the comb to be easily and quickly attached to and detached from one blade of the shears. Along the top portion of the spine of the comb there are two opposing flaps. The two flaps are configured to create an interference fit therebetween and thereby secure the bottom portion of one blade of the shears. Therefore, the comb may be attached by sliding the opposing flaps down one blade of the shears; or, alternatively, by snap-fitting the opposing flaps onto the bottom edge of one blade of the shears.

According to yet another embodiment, a clip is configured specifically to secure a comb within two opposing walls. With the clip securing a comb, the clip and comb combination may be slid within a specially configured blade of the shears. Additionally the clip and comb combination might be snapped into the blade of the shears. The blade of the shears is configured with a cutting portion on one edge and the opposing bottom edge is configured with a channel running longitudinally along the length of the blade. The channel is defined by two walls configured to receive and secure the clip. With the clip securing a comb, and the clip slid or snapped into the bottom edge channel of one blade of the shears, the shears effectively have a comb that is easily detached or attached as is desired.

It will be apparent that according to several embodiments, a traditional or common pair of shears can be mated with a specially configured comb. According to alternative embodiments, a traditional comb can be mated with a specially configured pair of shears. Finally, several embodiments may allow an adapter, such as a magnet or clip, to secure a traditional comb to a traditional pair of shears; this may be desirable in that any comb and shears combination can be used.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a front view of a comb and shears device of the present system and method, according to one exemplary embodiment.

FIG. 2 is a front view of another comb-and-shears device of the present system and method, according to on exemplary embodiment.

FIG. 3 is a perspective view of yet another comb and shears combination of the present system and method, according to one exemplary embodiment.

FIG. 4 is a perspective view of the comb and shears combination of the present system and method, according to one exemplary embodiment.

FIG. 5 is a side view of a comb configured to be attached to a shear, according to one exemplary embodiment.

FIG. 6 is a perspective view of a comb secured to a blade belonging to shears, according to one exemplary embodiment.

FIG. 7 is a front view of a clip configured to secure a comb to a shear, according to one exemplary embodiment.

FIG. 8 is a side view of a clip configured to secure a comb to a shear, according to one exemplary embodiment.

FIG. 9 is a perspective view of a clip configured to secure a comb to a shear, according to one exemplary embodiment.

FIG. 10 is a side view of a clip shown securing a comb, according to one exemplary embodiment.

FIG. 11 is a front view illustrating a clip partially secured to a comb, according to one exemplary embodiment.

FIG. 12 is a front view illustrating a clip fully secured to a comb, according to one exemplary embodiment.

FIG. 13 is a front view illustrating a comb secured to a shear through the use of a clip, according to one exemplary embodiment.

FIG. 14 is a perspective view of a clip securing a comb, according to one exemplary embodiment.

FIG. 15 is a close-up perspective view of a clip secured to a shear, according to one exemplary embodiment.

FIG. 16 is a front view of a comb secured to a pair of shears, according to one exemplary embodiment.

FIG. 17 is a close-up view of a comb secured to a pair of shears, according to one exemplary embodiment.

In the figures, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings. Throughout the drawings, identical reference numbers designate similar but not necessarily identical elements.

### DETAILED DESCRIPTION

The following description provides a number of exemplary connection members and methods for attaching a comb to a pair of shears. According to the present exemplary system and method a comb is attached to a pair of shears in a manner allowing the comb to be detached and reattached as desired. According to one specific embodiment, a comb is configured with magnets along the spine of the comb. The magnets detachably secure the spine of the comb to the outside front face of a blade of a pair of shears. The magnets secure the comb sufficient to allow the comb to be used in any manner normally associated with a comb without worry that the comb will become detached from the blade of the shears.

According to another embodiment, the comb is configured with voids or holes in a keyhole shape. That is, the holes or voids have a wider portion and a narrower portion. The shears are configured with corresponding bolts configured to be mated with the keyhole voids. The bolts have a wider head portion and a narrower shaft portion. According to this embodiment, the comb can be placed on the bolts in such a manner so as to allow the bolts to enter the wider portion of the keyhole voids, the comb is then translated along the length of the blade causing the shafts of the bolts to enter the narrow portions of the keyhole voids. In this position the comb is secured to the blade because the head of the bolt is too wide to pass through the narrow portion of the keyhole void. One exemplary embodiment is illustrated in FIG. 3, and will be explained in detail below.

According to yet another embodiment, a comb is specifically configured to receive the bottom edge of a blade of a pair of shears. The top edge of the spine of the comb is specifically configured with two opposing flaps; the flaps are capable of compressionally securing the blade of a shear. According to this embodiment, the teeth of the comb extend away from the bottom edge of the blade belonging to a pair of shears. The bottom edge is best defined as being the edge of a blade on the opposing side from the cutting edge of the blade.

Finally according to an additional embodiment, a clip member is configured to secure a comb to a pair of shears specifically designed to receive and secure the clip. Accordingly, a clip member is configured to secure a specific comb, or a clip member may be configured so as to allow its use with a variety of comb shapes and sizes. The clip member may alternatively be integrated with the spine of a comb, consequently the comb would be specifically configured to be received by the specially adapted shears. The shears, according to this embodiment, have at least one blade specifically configured to receive the clip member and/or clip-and-comb combination. The blade has a cutting edge and opposite this cutting edge a bottom edge. The bottom edge is configured with a channel defined by two opposing walls capable of receiving the clip member. The two opposing walls act to secure the clip member through an interference fit within the channel.

According to one variation of the above embodiment involving a clip, the clip member and corresponding comb are snapped in place. According to an alternative variation, the clip member and comb are slideably attached and detached. It is also conceivable that the comb and clip can be both snapped or slid into place as is convenient. Additionally, just as the clip could be integrated with the comb, the clip could be integrated with the shears. Also it is possible that the bottom edge or other portion of the shears be specifically configured with two opposing walls capable of directly receiving and compressionally securing the spine of a comb; the comb may be specifically configured for this purpose, or alternatively, the receiving walls of the shears may be configured so as to secure a wide variety of combs.

Each of the above-described embodiments will be described in detail below. Associated with the description found below are several illustrations offering examples of the above-described embodiments that provide better understanding of each of the embodiments. It should be understood that the illustrations as well as the description found below are of various exemplary embodiments, many variations are possible without deviating from the spirit of the exemplary disclosure and not all are described in detail.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “one embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment. Additionally, the term “shears” is intended to represent any number tonsorial devices designed for cutting hair, including scissors; consequently the terms “shears” and “scissors” are used interchangeably throughout the specification.

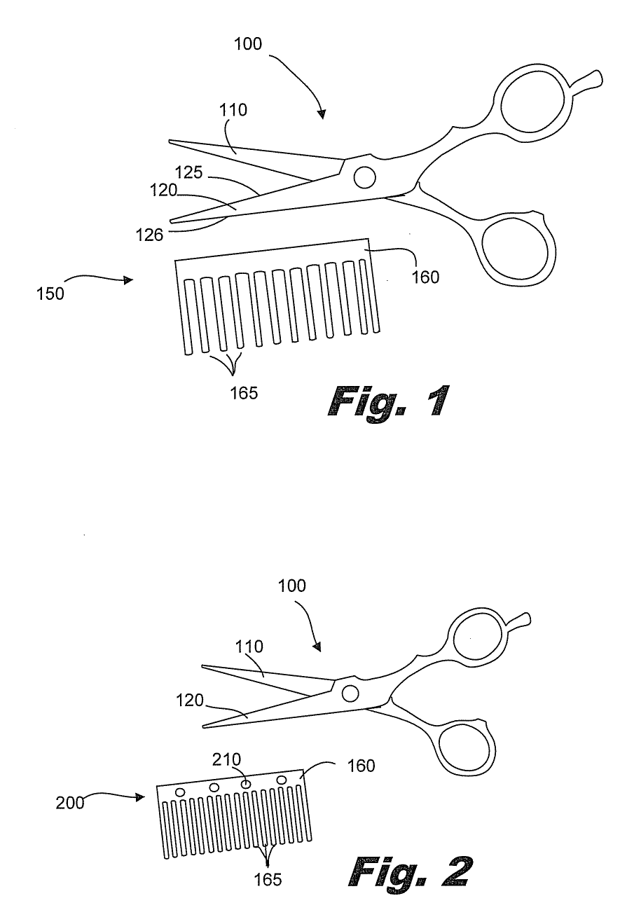

As shown in the figures, a comb-and-shears apparatus includes a comb (150) releasably attached to a pair of shears (100). As shown in FIGS. 1 and 2, the comb (150) is disposed along a first blade (120) of the pair of shears (100). When the comb (150) is attached to the shears (100), a plurality of teeth (165) of the comb (150) project outwardly from the spine (160) of the first blade (120) away from the cutting edge (125) of the first blade (120). Therefore, the comb is either attached to one side of the blade, or the bottom edge (126) of the first blade (120).

Turning now to FIG. 1, a comb (150) and shears (100) are shown according to one exemplary embodiment. As shown in FIG. 1, the comb (150) has a plurality of teeth (165) projecting from a spine (160) thereof. The teeth (165) may be any number, size and shape well known in the art useful for combing hair. In this example, the comb (150) may be configured to allow the user to permanently attach the comb (150) to any pair of scissors (100). The comb (150) may be attached through the use of adhesives such as glue, epoxy, superglue, Velro™, or any other similar adhesive. It may, according to several variations of this embodiment, be possible to secure the comb to the shears and subsequently remove the comb for cleaning or whenever else may be desired.

Turning now to FIG. 2, a comb (150) and shears (100) are shown according to one exemplary embodiment. In this example, the comb (150) comprises four magnets (210) that may be used to releasably attach the comb (150) to any pair of metal scissors or shears (100). Additionally opposing magnets could be placed on non-metallic shears so as to allow the comb to be attached. The magnets (210) should be of sufficient strength so as to keep the comb (100) in place as it is used to comb through a person's hair. In other embodiments, other methods may be utilized to allow the comb (150) to be releasably attached to the scissors (100). Also demonstrated in FIG. 2, is a comb (150) that has significantly more teeth (165), than the comb (150) in FIG. 1. This demonstrates the ability for many different sizes, shapes, and types of combs (150) to be used. As shown in FIG. 2, four magnets (210) are attached to the comb (150), however it is readily obvious that more or less magnets could be used depending on size, strength, and shape. It is also possible to configure the blade (120) of a pair of scissors (100) with magnets rather than the comb (150). Also, both the shears and the comb may have magnets for quick alignment of the shears (100) and comb (150) or for added strength.

As shown in FIG. 3, the comb (150) has a plurality of teeth (165) projecting from a spine (160) thereof. The teeth (165) may be any number, size and shape well known in the art useful for combing hair. In this exemplary embodiment, the scissors (100) comprise two bolts (310) that protrude, preferably tangentially, from the front face of the first blade (120) of the scissors (100). The comb (150) comprises two keyhole shaped voids or holes (320), as is depicted in FIG. 3. The bolts (310) are configured to be able to fit through the largest diameter of the corresponding holes (320) in the comb (150). The comb (150) can then be slid so that the narrowing sides of the holes (320) are compressed against the sides of the bolts (310). This compression, in conjunction with pressure from the bottom of the bolt's (310) head against the top of the comb (150), holds the comb (150) in place with sufficient force to allow use of the comb without separation of the comb from the shears.

FIG. 4 demonstrates another exemplary method of attaching the comb (400) to the shears (100). The spine (440) of the comb (150) may include a channel (420) for receiving a blade (120) of a pair of shears (100). As illustrated in FIG. 4, the exemplary channel (420) includes a first side flap (410) and a second side flap (430). The first (410) and second (430) side flaps may be configured to compress against the sides of a blade (120) of the scissors (400) when the blade (120) is slid into the channel (420), holding the comb (400) in place.

FIG. 5 shows a view of the end of the comb (400) described above in conjunction with FIG. 4. As illustrated in FIG. 5, the ridge (400), channel (420), and flaps (410, 430) referred to above, are depicted and clearly illustrate each of these components according to one exemplary embodiment. According to one exemplary embodiment, the distance between the two flaps (410, 430) is less than the width of the blade (120) of a pair of shears (100) and the flaps are configured to create an interference fit sufficient to secure the comb (400) to the blade (120) when the comb is passed between the flaps.

FIG. 6 shows a perspective view of the comb (400) illustrated in FIG. 4. As illustrated in FIG. 6, a cut-away view of the blade (120) of the scissors (100) is also depicted as well as the teeth (465) of the comb (400). As illustrated in FIG. 6, the flaps (410, 430) are securing a blade (120) within the channel (420). The flaps (410, 430) create an interference fit with enough force so as to render the blade (120) captured within the channel (420) during use. It can also be seen, as has been previously mentioned, that the comb (400) and its teeth (465) extend away from a bottom edge (126) directly opposite the cutting edge (125) of the blade (120).

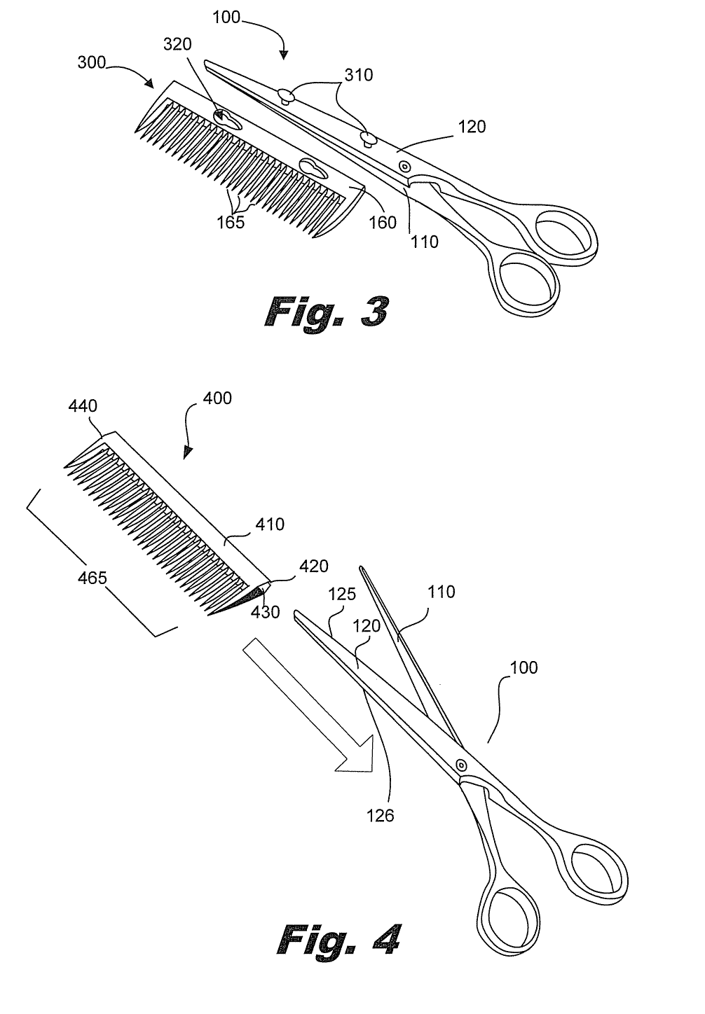

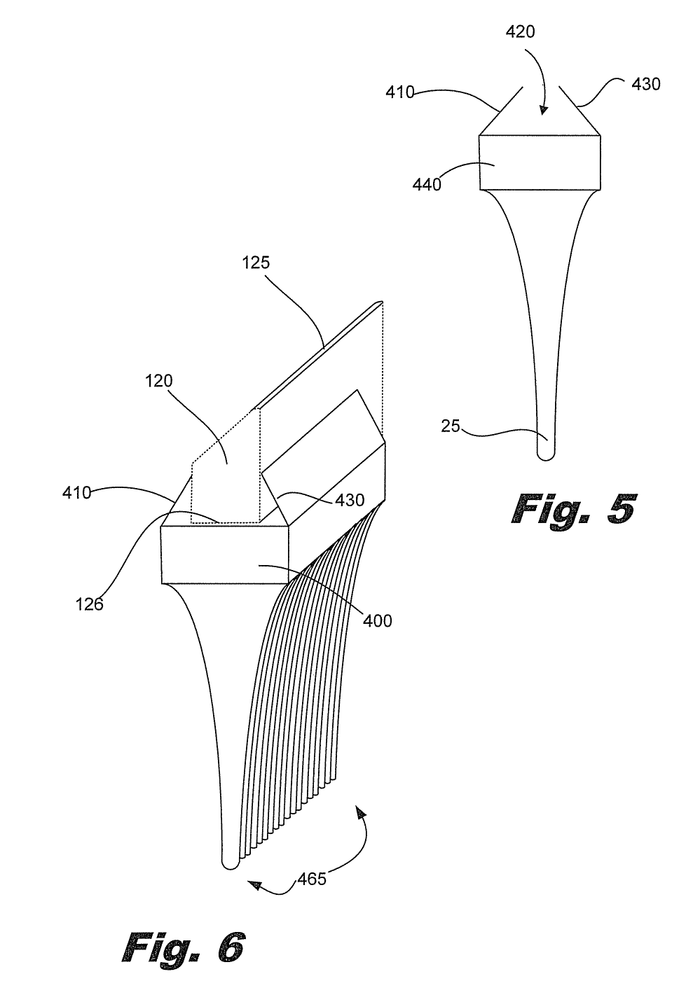

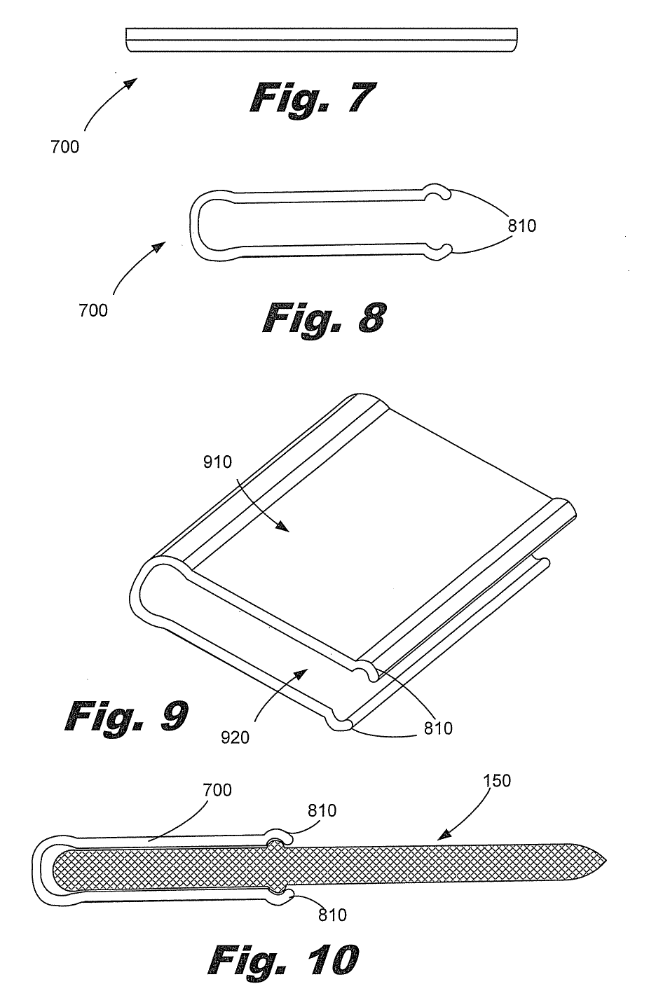

According to an additional embodiment described above, a clip is used to secure a comb to a pair of shears. As has been previously disclosed, the clip may be integrated into the comb or the shears, or it may be an entirely separate member. The clip may be configured to interact with a specific comb or with various combs. The clip may be configured to interact with a specific pair of shears or with any number of shears of varying sizes and shapes. Regardless, various methods involving compressional walls, flaps, slots, snaps, may be utilized and accommodated for. One exemplary embodiment of a tonsorial system allowing a comb to be attached to a pair of shears is depicted in FIGS. 7-17.

As illustrated, FIG. 7 depicts a frontal view of a clip (700) used for securing a comb and subsequently securing the comb (700) to a pair of shears. According to one exemplary embodiment, the length and width of the clip (700) can be modified to accommodate various combs and shears. Clearly, the clip (700) could be much shorter than the comb and/or shears and still be capable of securing a comb to the shears sufficiently to allow normal use of the comb without causing separation of the comb from the shears.

FIG. 8 is a side view of the clip (700) portrayed in FIG. 7, according to one exemplary embodiment. As illustrated in FIG. 8, the clip (700) comprises two walls. The clip (700), as illustrated, has a profile specifically configured for optimally securing a comb within the two walls. Various alternative embodiments include a variety of sidewall shapes and sizes. Depending on the shape and size of the comb used, the clip (700) may be configured in such a way so as to capture, frictionally secure, or snap a comb in place.

FIG. 9 is a perspective view of the same clip (700) described in conjunction with FIGS. 7 and 8. In the perspective view it can be clearly seen that the clip has a width defined by the upper wall (910) and the lower wall (920). The width is determined by the comb designed to be coupled to the clip (700). The walls (910, 920) are configured to expand slightly, without yielding, as the spine (160, FIG. 1) of a comb (150, FIG. 1) enters and thereafter secure the spine (160, FIG. 1) of the comb (150, FIG. 1) within the two walls (910, 920) of the clip (700). The shape of the walls (910, 920) is shown as being contoured, however, various embodiments include many variations of contours including no contour at all. It is also possible that the contoured walls (910, 920) can be specifically configured with end protrusions and/or recesses (810) that are configured to interact with a comb in a specific manner so as to better secure the comb within the clip (700).

FIG. 10 shows a side view of a clip (700) securing a comb (150), according to one exemplary embodiment. According to this embodiment, the end protrusions or recesses (810) are providing additional support. The protrusions or recesses (810) of the clip (700) interact with a protrusion on the comb (150) and thereby provide a locking effect. The comb (150) can therefore be slid into the clip (700) and thereafter remain locked within the clip (700).

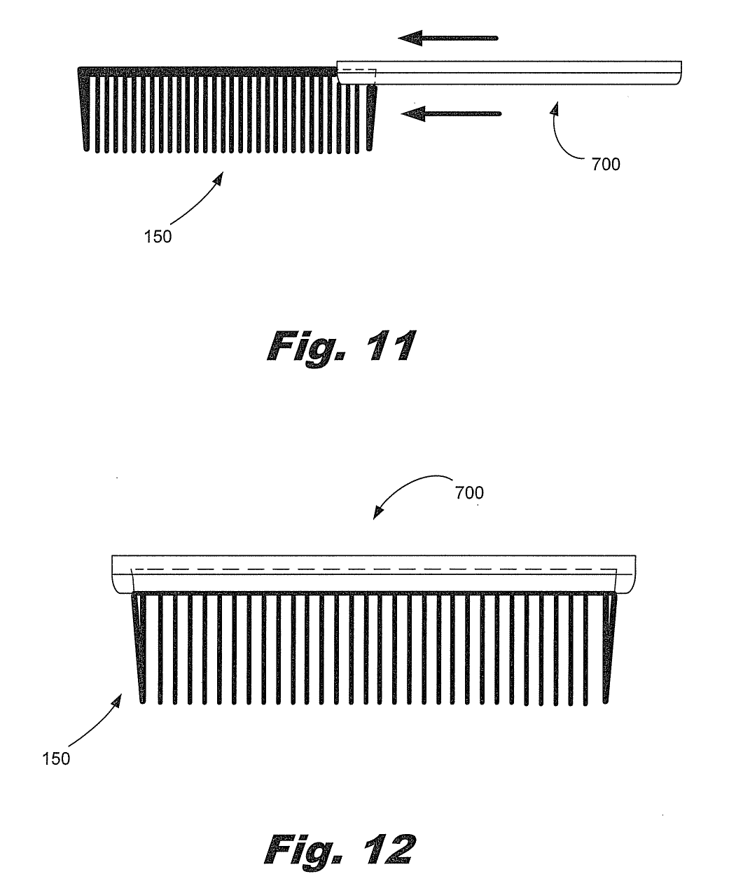

FIG. 11 illustrates an exemplary clip (700) securing a comb (150). As is illustrated, the comb (150) is slid into place, however according to alternative embodiments the clip (700) and comb (150) may be snapped together or fitted in another manner. FIG. 11 depicts the comb (150) partially slid into place within the clip (700). FIG. 12 illustrates the comb (150) completely secured by the clip (700). The spine (160) of the comb (150) can be seen in dashed lines within the two walls (910, 920, FIG. 9) of the clip (700). According to the exemplary embodiment shown in FIG. 12, the comb (150) is secured within the clip (700) and is prevented from release except by sliding the comb (150) out of the clip (700) after overcoming the securing force of the interaction between the comb and the clip.

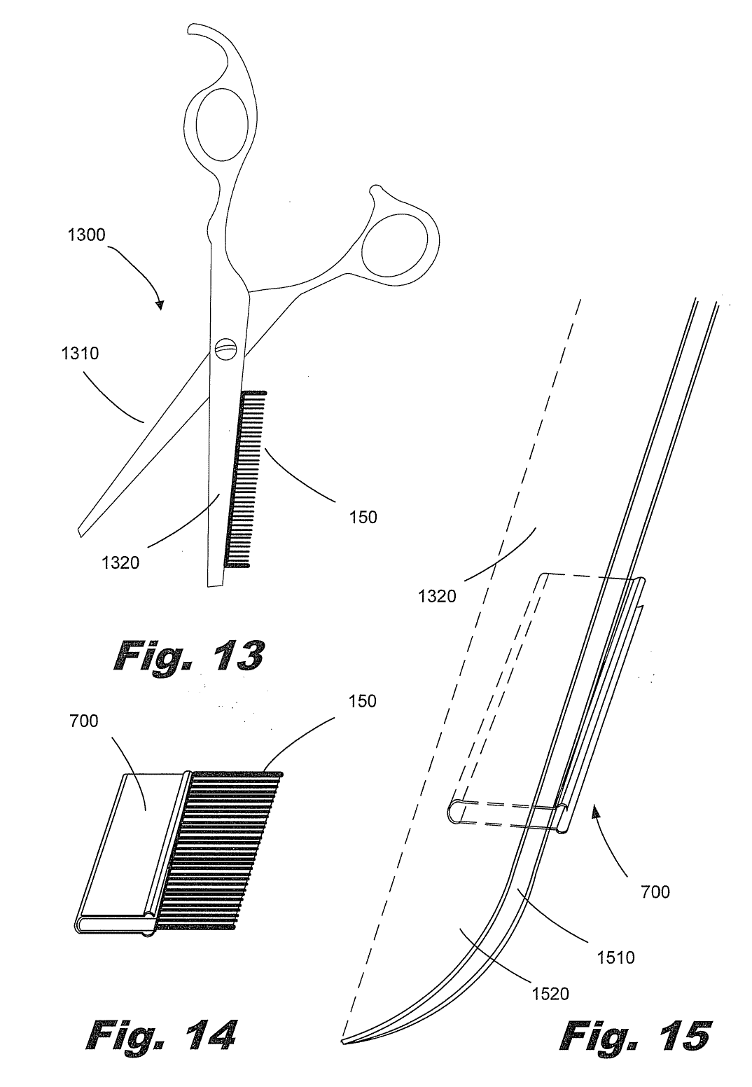

FIGS. 13, 14, and 15 illustrate how the clip (700) and a secured comb (150) are mated with a pair of shears or scissors (1300). FIG. 13 illustrates a completely assembled tonsorial device including a pair of shears (1300), a clip (700), and a comb (150). As illustrated, the clip (700) secures the comb (150) as previously described in conjunction with FIGS. 7-12 and the clip (700) is secured by the shears (1300). As is clearly depicted, according to one exemplary embodiment, in FIG. 13, the shears (1300) are shown fully securing a comb (150); this is a final assembled system and method. According to various embodiments, the comb (150) is easily removed from the shears (1300) by either sliding the clip (150) out of the shears (1300), snapping the clip (150) out of the shears (1300), or any combination of snapping or sliding according to the embodiment.

FIG. 14 is similar to FIG. 12 and illustrates a perspective view of a comb (150) secured by a clip (700). FIG. 15 depicts the interaction of a clip (700) and the bottom edge of a blade (1320) of a pair of shears (1300). As can be clearly seen in the close-up view of the blade (1320), the bottom edge has a front wall (1520) and a rear wall (1510). The front and rear walls (1510, 1520), according to one exemplary embodiment, are configured to slideably receive the clip (700). According to an alternative embodiment the front and rear walls (1510, 1520) are configured to receive the clip (700) directly in such a way that the clip (700) effectively snaps in and out of the channel created by the two walls (1510, 1520). Alternatively, the clip (700) may be configured to interact with the two walls (1510, 1520) both slideably and by snapping in and out.

According to one exemplary embodiment, the two walls (1510, 1520) may not extend fully to the cutting edge (125, FIG. 1) but rather only partially towards the middle of the blade (1320); this is depicted in FIG. 15 by the dashed line of the blade (1320). According to various exemplary embodiments the clip (700) is retained effectively within the blade (1320) as the clip (700) also retains the comb (150) during normal use of the comb (150) and shear (100) combination.

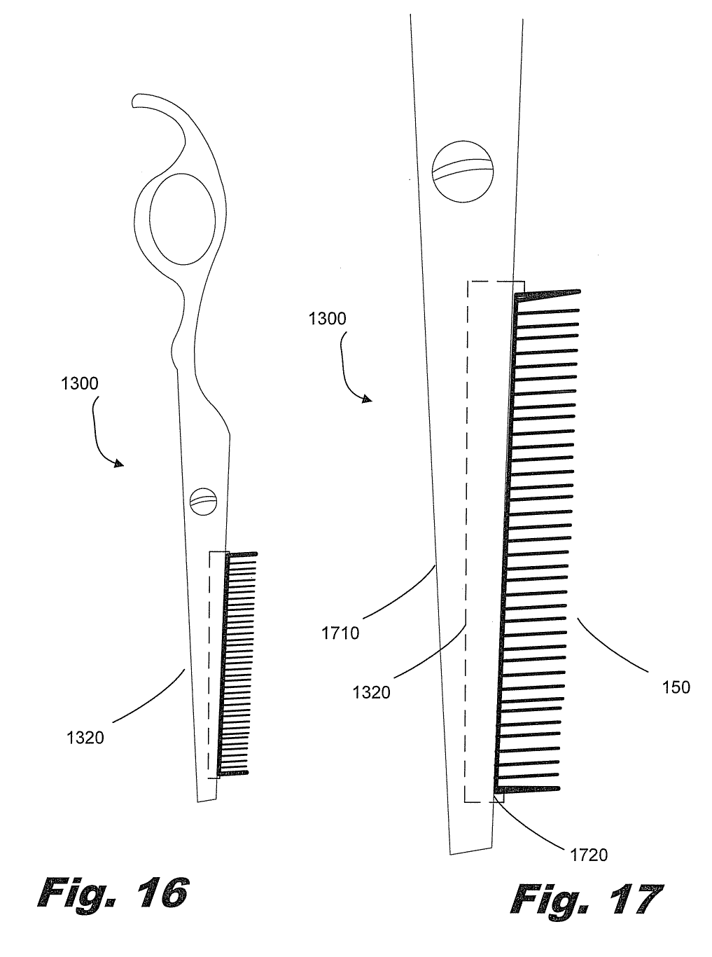

Both FIGS. 16 and 17 depict a completely assembled comb (150) and shear (1320) combination. FIG. 16 illustrates one blade (1320) of the shears (1300) with a comb (150) secured by a clip (shown in dashed lines within the blade (1320)). The clip (dashed lines) and comb (150) are secured within the blade (1320). FIG. 17 shows a close-up view of FIG. 16. The clip (dashed lines) is shown being secured by the blade (1320). The clip (dashed lines) secures a comb (150) with the teeth of the comb (150) extending away from a bottom edge (1720) that is on an opposite side from the cutting edge (1710) of the blade (1320).

The preceding description has provided several exemplary embodiments of a tonsorial device including shears and a detachable comb. The description in conjunction with the figures provides several examples according to various exemplary embodiments; however it should be understood that many variations and modifications of the preceding description are possible and have not been described in detail due to their vast number. It will be understood that various modifications may be made without departing from the spirit and scope of the present exemplary systems and methods.

The preceding description has been presented only to illustrate and describe embodiments and examples of the principles described. This description is not intended to be exhaustive or to limit these principles to any precise form disclosed. Many modifications and variations are possible in light of the above teachings. It is intended that the scope of the invention be defined by the following claims.

What is claimed is:

1. A tonsorial device comprising:
a first shear member and a second shear member, each of said first and second sear members having a handle portion and a cutting portion;
a pivot assembly pivotally attaching said shear members between said handle portions and said cutting portions; and
a comb detachably connected to at least one of said shear members.

2. The device of claim 1, wherein said comb includes a plurality of teeth projecting outwardly from an outer edge of one of said shear members in a direction away from said cutting portion of one of said shear members.

3. The device of claim 1, wherein said comb is configured with a channel disposed along a spine of said comb, said channel receiving an outer edge of one of said shear members.

4. The device of claim 3, wherein said channel comprises a first side wall and a second side wall, said first side wall engageable with an outer side of said one of said shear members, and said second wall engageable with an inner side of said one of said shear members.

5. The device of claim 1, wherein at least one of said shear members further comprises at least one protruding bolt.

6. The device of claim 5, wherein said comb further comprises at least one keyhole shaped void spaced and shaped to accept and engage said at least one protruding bolt.

7. The device of claim 1, wherein said comb is attached to said one of said shears through the use of an adhesive.

8. The device of claim 1, wherein said comb and shear combination further comprises at least one magnet configured to attach said comb to one of said shears.

9. A tonsorial device comprising a plurality of shears, each shear of said plurality of shears having a handle portion and a cutting portion;
a pivot assembly pivotally attaching said plurality of shears;
wherein at least one of said plurality of shears includes a channel on an edge opposing the cutting portion of said shear.

10. The tonsorial device of claim 9, wherein said channel is configured to receive the spine of a comb having teeth to secure said comb in said channel, wherein said teeth of said comb are positioned to extend away from said cutting portion of said shear.

11. The tonsorial device of claim 9, wherein said channel is configured to receive a spine of any one of a plurality of combs of varying shapes and sizes, said combs having teeth, wherein said teeth of said comb are positioned to extend away from said cutting portion of said shear.

12. The tonsorial device of claim 9, wherein said channel is configured to receive and detachably secure a clip;
said clip being configured to compressibly secure at least one of a variety of combs.

13. A tonsorial device comprising a pair of shears, each shear of said pair of shears including a handle portion and a cutting portion;
a pivot assembly pivotally attaching said shears between said handle portions and said cutting portions;
a comb comprising a spine and teeth; and
a clip configured to detachably secure said comb to one of said pair of shears.

14. The tonsorial device of claim 13, wherein one of said pair of shears includes a channel opposing said cutting portion of said shear;
said channel being defined by a first and a second wall;
said first and second walls being configured to capture and retain said clip.

15. The tonsorial device of claim 13, wherein said comb is configured to be compressibly retained by said clip.

16. The tonsorial device of claim 13, wherein said comb is configured to be slideably coupled to said clip.

17. The tonsorial device of claim 13, wherein:
said comb is configured to be slideably coupled within a plurality of walls of said clip member; and
said clip member is configured to be detachably secured within a channel defined by one of said shears;

18. The tonsorial device of claim 17, wherein said channel is defined on an opposing edge of said shear relative to said cutting portion.

19. The tonsorial device of claim 18, wherein said comb is secured within said clip member with said teeth extending away from said cutting portion of said shear when said clip member is coupled to said shear.

20. The tonsorial device of claim 13, wherein said clip is configured to compressibly receive said spine of said comb, creating a clip and comb combination; and
wherein one of said shears is configured with a channel on an edge opposing said cutting portion of said shear;
said channel being configured to receive and detachably secure said clip and comb combination, securing said comb with said teeth extending away from said cutting portion.

21. The tonsorial device of claim 20, wherein said clip comprises a proximal end and a distal end, said distal end being configured to be disposed in said channel; and
wherein said proximal end of said clip further comprises at least one recess configured to receive a mating protrusion formed on said comb.
